(19) United States
(12) Patent Application Publication
(10) Pub. No.: US 2016/0318060 A1
(43) Pub. Date: Nov. 3, 2016

(54) AN ASSEMBLY FOR USE IN A LIQUID DROPLET APPARATUS

(71) Applicant: KONINKLIJKE PHILIPS N.V., Eindhoven (NL)

(72) Inventor: DIRK ERNEST VON HOLLEN, CLARK, NJ (US)

(73) Assignee: Koninklijke Philips N.V., Eindhoven (NL)

(21) Appl. No.: 15/105,591

(22) PCT Filed: Dec. 12, 2014
(86) PCT No.: PCT/EP2014/077475

§ 371 Date: Jun. 17, 2016

(30) Foreign Application Priority Data
Dec. 19, 2013 (EP) 13198639.0

(51) Int. Cl. B05B 17/00

(52) U.S. Cl. CPC B05B 17/0646

(57) ABSTRACT

An assembly for use in a liquid droplet apparatus comprises a vibrating element (11), an aperture plate (15) and a vibrating platform (13). The vibrating platform (13) is positioned between the vibrating element (11) and the aperture plate (15) for conveying vibrations from the vibrating element (11) to the aperture plate (15). The vibrating platform comprises a first portion (13a) coupled to the vibrating element, a second portion (13b) coupled to the aperture plate, and wherein the first and second portions of the vibrating platform are detachably connected to one another.

### TECHNICAL FIELD

The present invention relates to an assembly for use in a liquid droplet apparatus for producing liquid droplets, for example for use in ultrasonic mesh aerosol nebulizer devices, and in particular to an aerosol apparatus having a detachable mesh to allow for replacement.

### BACKGROUND

Previous ring style mesh aerosol systems are described as single piece assemblies where the mesh is permanently attached to the vibrating structure, which in turn is permanently attached to the ultrasonic piezo ring. These meshes have been described as fabricated from either a metallic or polymer material that contains many tiny openings or micro nozzles that produce a fine droplet when vibrated. Over time the mesh is exposed to various drug solutions and suspensions, as well as cleaning liquids. The mesh materials will therefore deteriorate or get clogged over time, which will hamper the output of spray, resulting in the single piece assembly having to be replaced in the nebulizer device.

### SUMMARY

It is an aim of the present invention to provide an apparatus and method which obviate or reduce at least one or more of the disadvantages mentioned above.

According to a first aspect of the present invention there is provided an assembly for use in a liquid droplet apparatus. The assembly comprises a vibrating element, an aperture plate and a vibrating platform. The vibrating platform is positioned between the vibrating element and the aperture plate for conveying vibrations from the vibrating element to the aperture plate. The vibrating platform comprises a first portion coupled to the vibrating element, a second portion coupled to the aperture plate, wherein the first and second portions of the vibrating platform are detachably connected to one another.

This has the advantage of enabling the aperture plate (or mesh) to be replaced without having to replace the entire assembly, thus avoiding the need to replace the vibrating element (for example a piezoelectric ring).

The first portion of the vibrating platform may be fixedly coupled to the vibrating element, and the second portion of the vibrating platform may be fixedly coupled to the aperture plate.

The first portion of the vibrating platform may be formed from a polymer material. Alternatively, the first portion of the vibrating platform may be formed from a metal.

The second portion of the vibrating platform may be formed from a polymer material. Alternatively, the second portion of the vibrating platform may be formed from a metal.

The first and second portions of the vibrating platform may be made from the same material, or a different material.

The first portion and the second portion of the vibrating platform may be of similar thicknesses, or of different thicknesses.

The first portion and/or the second portion may be made from a polymer material that is injection moulded with at least one section which is formed without pre-stress.

The vibrating platform may be made from a material that is transparent to a light source, for allowing the light source to cure an adhesive used in the assembly of one or more components of the assembly.

According to one example, an interface between the first and second portions of the vibrating platform, where the first and second portions of the vibrating platform are detachably connected, may comprise first and second surfaces which are generally orthogonal to the plane of the vibrating element.

In such an example, when the aperture plate needs to be replaced the disposable screen section, that is the second portion of the vibrating platform (or disposable flex form) slides off or detaches from the first portion of the vibrating platform (or fixed form).

According to one embodiment an undercut may be provided to retain the mesh in place (to retain the second portion of the vibrating platform in contact with the first portion of the vibrating platform), which can be snapped off when the mesh needs to be replaced.

According to another example, an interface between the first and second portions of the vibrating platform, where the first and second portions of the vibrating platform are detachably connected, may comprise first and second surfaces which are sloped or slanted with respect to the plane of the vibrating element.

According to another aspect of the invention there is provided a first vibrating platform portion for use in an assembly of a liquid droplet apparatus, the first vibrating platform portion being coupled to a vibrating element, wherein during use the first vibrating platform portion is coupled to a second vibrating platform portion that is coupled to an aperture plate.

According to another aspect of the invention there is provided a second vibrating platform portion for use in an assembly of a liquid droplet apparatus, the second vibrating platform portion being coupled to an aperture plate, wherein during use the second vibrating platform portion is coupled to a first vibrating platform portion that is coupled to a vibration element.

According to another aspect of the present invention, there is provided an assembly for use in a liquid droplet apparatus. The assembly comprises a vibrating element and a vibrating platform. The vibrating platform comprises a first portion coupled to the vibrating element, a second portion comprising a plurality of holes, wherein the first and second portions of the vibrating platform are detachably connected to one another.

In the embodiment above, the nozzles are formed directly in the material of the vibrating platform, the vibrating platform itself having first and second parts. One part is connected to the vibrating element, for example permanently connected, for example using an adhesive. The other part is detachably connected to the first part, and comprises inbuilt nozzles in the material of the second part of the vibrating platform.

### BRIEF DESCRIPTION OF THE DRAWINGS

For a better understanding of examples of the present invention, and to show more clearly how the examples may be carried into effect, reference will now be made, by way of example only, to the following drawings in which:

FIG. 1 shows an assembly according to a first embodiment;

FIG. 2 shows the assembly of FIG. 1 in a detached state;

FIG. 3 shows an assembly according to another embodiment;

FIG. 4 shows an assembly according to another embodiment;

FIG. 5 shows an assembly according to another embodiment;

FIG. 6 shows an assembly according to another embodiment;

FIG. 7 shows the assembly of FIG. 6 in an assembled state;

FIG. 8 shows an assembly according to another embodiment;

FIG. 9 shows an assembly according to another embodiment; and

FIG. 10 shows an assembly according to another embodiment.

### DETAILED DESCRIPTION

Preliminary, it should be clearly understood that in the meaning of the invention the terms “vibrating element” and “vibrating platform” equally designate or be construed as an element and a platform that are configured to vibrate, respectively. It should further be clear that in the meaning of the invention any vibration related to this element of platform should occur during use only.

An objective of the embodiments of the present invention is to provide an improved assembly for use in an aerosol apparatus, such as an ultrasonic mesh aerosol nebulizer, having a mesh sub-assembly that is detachable from a sub-assembly housing a vibrating element, for example an ultrasonic piezo ring assembly.

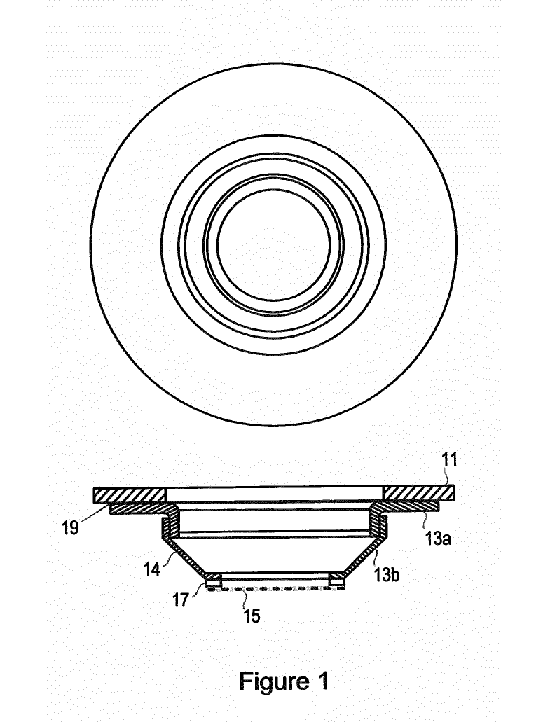

FIG. 1 is an example of a first embodiment, showing a plan view and a cross-sectional view of the apparatus in an assembled state. The apparatus comprises a vibrating element 11, for example a piezoelectric device (e.g. a piezoelectric ring device), an aperture plate 15 (such as a mesh or screen) and a vibrating platform 13. The vibrating platform 13 is positioned between the vibrating element 11 and the aperture plate 15 for conveying vibrations from the vibrating element 11 to the aperture plate 15. As such, during use, vibrations generated by the vibrating element 11 are transmitted through the vibrating platform 13, causing the aperture plate 15 which is attached thereto to vibrate. The vibrating platform comprises a first portion 13a that is coupled to the vibrating element 11, and a second portion 13b that is coupled to the aperture plate. The first and second portions 13a, 13b of the vibrating platform are detachably connected.

The detachable connection of the first portion 13a and the second portion 13b of the vibrating platform allows the aperture plate 15 to be detached and removed during use (with the corresponding second portion 13b of the vibrating platform), and replaced with a replacement aperture plate 15 (and corresponding second portion 13b of the vibrating platform). This has the advantage of enabling the aperture plate 15 to be replaced without replacing the entire mesh assembly, thus saving the cost of replacing the vibrating element 11 (e.g. piezoelectric element) each time the mesh is replaced.

In the embodiment of FIG. 1 the sidewalls of the second portion 13b of the vibrating platform are arranged to fit over the sidewalls of the first portion 13a of the vibration platform, where the first portion 13a and second portion 13b of the vibrating platform interface when coupled together. An inner part of the sidewall of the second portion 13b therefore interfaces with an outer part of the sidewall of the first portion 13a.

The first portion 13a may have a fixed form and the second portion 13b a flexible form. The flexible form of the second portion 13b, which also comprises a sloped section 14 which is slanted or angled with respect to a plane of the vibrating element 11, enables the second portion 13 to flex. This enables the surface of the second portion 13b which carries the aperture plate 15 to move in an axial direction of the vibrating element (i.e. upwards or downwards in the direction of the page), such that the aperture plate 15 can dispense a flow of fluid. The flexible form of the second portion 13b also enables the second portion 13b to be assembled onto the first portion 13a, such that the second portion 13b is held in place during use as a result of the flexible form of the second portion 13b pressing against the first portion 13a.

It is noted that the aperture plate 15 may comprise, for example, a screen, a mesh, a membrane, a machined metal plate, a polymer structure or the like, having many tiny openings or micro nozzles.

The first portion 13a may be fixedly coupled to the vibrating element 11, for example permanently coupled. The first portion may be fixedly coupled to the vibrating element, for example, using an adhesive 17, 19, although other methods are also possible. The second portion 13b may be fixedly coupled to the aperture plate 15, for example permanently coupled, for example using adhesive, or other methods.

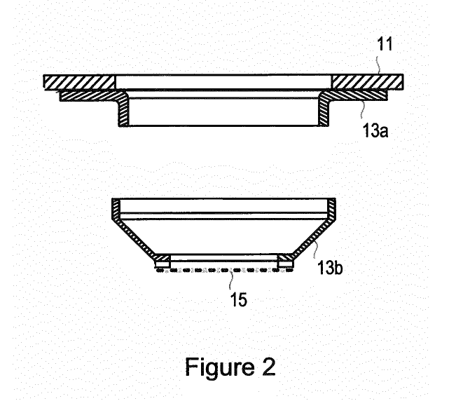

FIG. 2 shows the embodiment of FIG. 1 in a disassembled state, whereby the first portion 13a of the vibrating platform (i.e. which is coupled to the vibrating element 11) is shown as being disposed apart (i.e. detached) from the second portion 13b of the vibrating platform (i.e. which is coupled to the aperture plate 15).

The first and second portions 13a, 13b of the vibrating platform can be made of the same material, or each portion made from different materials. For example, the first and second portions 13a, 13b can be made from materials which include, but not limited to, metal or polymer materials.

When the aperture plate 15 needs to be replaced the disposable screen section, that is the second portion 13b of the vibrating platform (or disposable flex form portion) slides off or detaches from the first portion 13a of the vibrating platform (or fixed form portion).

According to one embodiment an undercut is provided to retain the mesh sub-assembly (second portion 13b) in place, which can be snapped off or pulled apart when the mesh needs to be replaced.

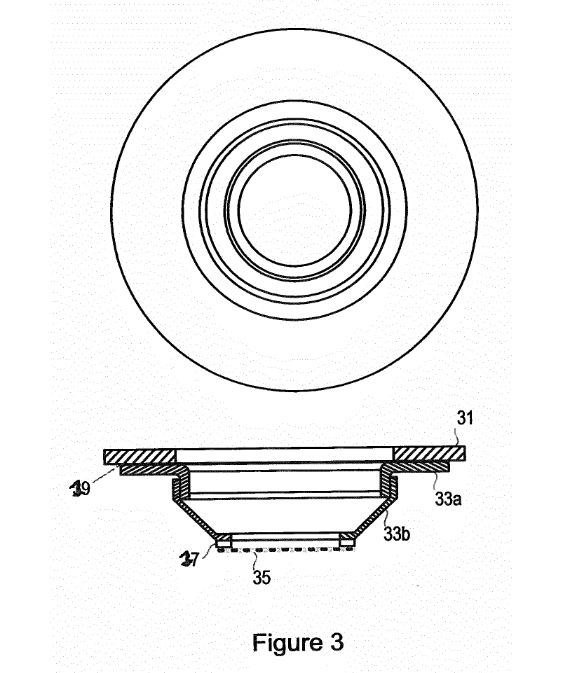

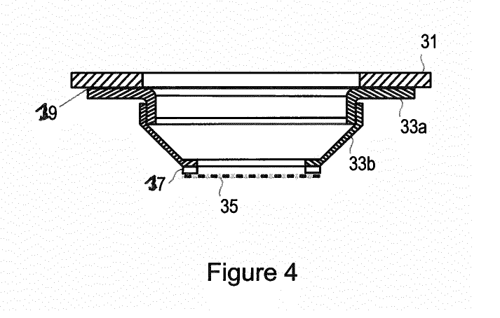

FIGS. 3 and 4 show examples of further embodiments in an assembled state, in which the first portion 33a and the second portions 33b of the vibrating platform are made from different materials.

In the example of FIG. 3, showing the apparatus in an assembled state, the apparatus comprises a vibrating element 31, for example a piezoelectric ring device, an aperture plate 35 and a vibrating platform 33. The vibrating platform 33 is positioned between the vibrating element 31 and the aperture plate 35. The vibrating platform comprises a first portion 33a (for example having a fixed form) that is coupled to the vibrating element 31, and a second portion 33b (for example having a disposable flexible form) that is coupled to the aperture plate 35. The first and second portions 33a, 33b of the vibrating platform are detachably connected. In this example the first portion 33a of the vibrating platform is formed from a polymer material, and the second portion 33b of the vibrating platform is formed from a metal.

In the embodiment of FIG. 3, the sidewalls of the second portion 33b of the vibrating platform are arranged to fit over the sidewalls of the first portion 33a of the vibration platform, where the first portion 33a and second portion 33b interface when coupled together.

FIG. 4 is an example of another embodiment, showing the apparatus in an assembled state. The apparatus comprises a vibrating element 31, for example a piezoelectric ring device, an aperture plate 35 and a vibrating platform 33. The vibrating platform 33 is positioned between the vibrating element 31 and the aperture plate 35. The vibrating platform comprises a first portion 33a (for example having a fixed form) that is coupled to the vibrating element 31, and a second portion 33b (for example having a disposable flexible form) that is coupled to the aperture plate 35. The first and second portions 33a, 33b of the vibrating platform are detachably connected. In this example the first portion 33a of the vibrating platform is formed from a metal, and the second portion 33b of the vibrating platform is formed from a polymer material.

In the embodiment of FIG. 4, as above the sidewalls of the second portion 33b of the vibrating platform are arranged to fit over the sidewalls of the first portion 33a of the vibration platform, where the first portion 33a and second portion 33b interface when coupled together.

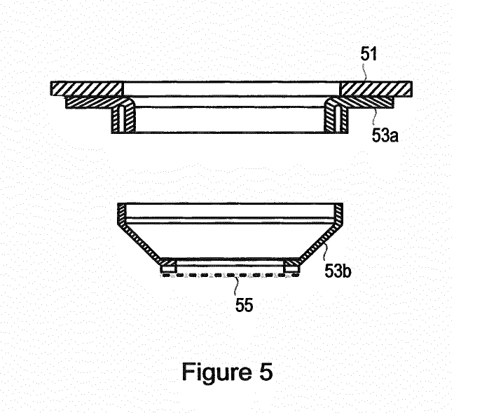

FIG. 5 is an example of another embodiment, showing the apparatus in a disassembled state. The apparatus comprises a vibrating element 51, for example a piezoelectric device, an aperture plate 55 and a vibrating platform 53. The vibrating platform 53 is positioned between the vibrating element 51 and the aperture plate 55 for conveying vibrations from the vibrating element 51 to the aperture plate 55. The vibrating platform comprises a first portion 53a (for example having a fixed form) that is coupled to the vibrating element 51, and a second portion 53b (for example having a disposable flex form) that is coupled to the aperture plate 55. The first and second portions 53a, 53b of the vibrating platform are detachably connected. According to this embodiment, instead of the wall of the second portion 53b being arranged to fit over the sidewall of the first portion 53a of the vibration platform where the first portion 53a and second portion 53b interface when coupled together, in this embodiment the wall of the second portion 53b of the vibrating platform is arranged to couple within a cavity formed in the wall of the first portion 53a.

In the embodiments of FIGS. 1 to 5, the interface between the first and second portions of the vibrating platform, where the first and second portions of the vibrating platform are detachably connected, comprises first and second surfaces which are generally orthogonal to the plane of the vibrating element.

The interface may be configured such that the first and second portions of the vibrating element slide apart or together. The tolerances can be defined such that friction between the first and second surfaces of the interface cause the first and second portions of the vibrating platform to be held in place when assembled, and during use, yet allow the first and second portions to be detached by a user when the aperture plate needs to be replaced.

According to one embodiment the interface may comprise one or more indents/grooves on respective surfaces of the interface to help retain the first and second portions of the vibrating platform together during use.

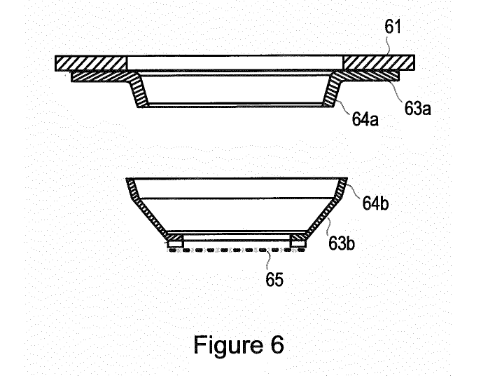

FIG. 6 shows an alternative embodiment in which the interface between the first portion 63a and the second portion 63b of the vibrating platform, i.e. the interface where they are detachably coupled, comprises first and second surfaces 64a, 64b which are sloped or slanted with respect to the plane of the vibrating element (i.e. a radial plane of the vibrating ring element). In the embodiment of FIG. 6, as with FIG. 1, the apparatus comprises a vibrating element 61, for example a piezoelectric ring device, an aperture plate 65 and a vibrating platform 63. The vibrating platform 63 is positioned between the vibrating element 61 and the aperture plate 65. The vibrating platform comprises a first portion 63a (for example having a fixed form) that is coupled to the vibrating element 61, and a second portion 63b (for example a disposable portion having a flexible form) that is coupled to the aperture plate 65. The first and second portions 63a, 63b of the vibrating platform are detachably connected. The sloped surfaces 64a, 64b enable the first and second portions to push fit together. FIG. 6 shows such an embodiment in the disassembled state (the detached state).

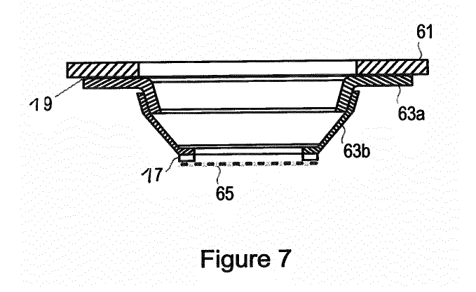

FIG. 7 shows the embodiment of FIG. 6 in the assembled state. The first and second portions 63a, 63b of the vibrating platform can be made of the same material, or each portion made from different materials, for example materials which include, but not limited to, metal or polymer materials. The choice of materials can also assist with the fit of the first and second portions.

According to one embodiment the means to couple the first and second portions of the vibrating platform include component interface geometries revolving on press or secure fit, and/or of selection of materials (metal or polymer) for fixed and disposable flex form, and/or having geometries that configured to optimize mesh movement. For example, a detachable mesh portion (a second portion of the vibrating platform) may comprise a combination of both a metal and polymer combination when connected to a metal fixed form platform (first portion of the vibrating platform). The metal portion can be configured to flex the polymer in order for aerosol to be produced through the center of the polymer mesh.

In embodiments of the invention the vibrating platform comprises an angled or sloped structure in some part of the structure between a part that is coupled to the vibrating element and a part that is coupled to the aperture plate. For example, in the embodiments of FIGS. 1 to 4 the angled portion is provided in the second portion of the vibrating element, i.e. the part connected to the aperture plate. The angled portion resides between the interface part which is orthogonal to the plane of the vibrating element. In this way contraction of the vibrating element in a radial direction (corresponding to the plane of the vibrating element) causes this angled structure to become less angled or less sloped, thus causing the aperture plate 15 to move in a “forward” direction, that is towards the bottom of the page in the diagrams. Similarly, expansion of the vibrating element in the radial direction causes the angled structure to become more angled or more sloped, thus causing the aperture plate 15 to move in a “backwards” direction, that is towards the top of the page in the diagrams

With regard to the embodiments described above, it is noted that alternatives to build the assembly include the following features, that allow for maximizing transmission of movement from the first portion of the vibrating platform (for example the fixed portion) to the second portion of the vibrating platform (for example the flexible portion):
polymer or metallic material for the construction of the fixed and flexible form embodiments of similar or varied thicknesses
combination of polymer and metal materials for the construction of the fixed and flexible form embodiments of similar or varied thickness
a transmission of movement via an angled structure contained in either the fixed or flexible form embodiments
polymer material that is injection molded with a joint without pre-stress to assist in maximizing displacement
polymer material that is transparent to allow UV adhesive curing of component directly onto either fixed or flexible form embodiments.

According to one embodiment, the first portion and the second portion are of similar thicknesses.

According to another embodiment, the first portion and the second portion are of different thicknesses.

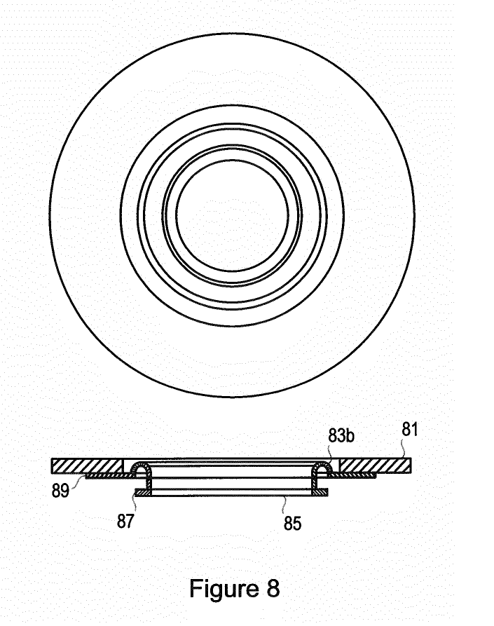

According to one embodiment the first portion and/or the second portion of the vibrating platform are made from a polymer material that is injection moulded with a joint without pre-stress to assist in maximizing displacement. FIG. 8 shows an example of such an apparatus. This aspect can be used with a vibrating platform which comprises first and second portions, i.e. which are detachably connected, or a vibrating platform made from a single structure, i.e. a non-detachable embodiment.

Thus, according to another aspect of the invention, there is provided an assembly for use in a liquid droplet apparatus. The assembly comprises a vibrating element, an aperture plate and a vibrating platform. The vibrating platform is positioned between the vibrating element and the aperture plate for conveying vibrations form the vibrating element to the aperture plate. The vibrating platform is formed from injection moulding, such that one or more sections of the vibrating platform are formed without pre-stress.

In one embodiment the nozzles may be formed directly in the material of the vibrating platform, rather than having a separate aperture plate. This aspect may be applied to any of the embodiments described herein.

According to another embodiment, the vibrating platform is made from a material that is transparent to a light source, for allowing the light source to cure an adhesive used in the assembly of one or more components of the assembly.

For example, the vibrating platform can be made from a polymer material that is transparent to allow UV adhesive 89 curing of components directly onto either the first portion of the vibrating element (fixed form) or the second portion of the vibrating element (flexible form).

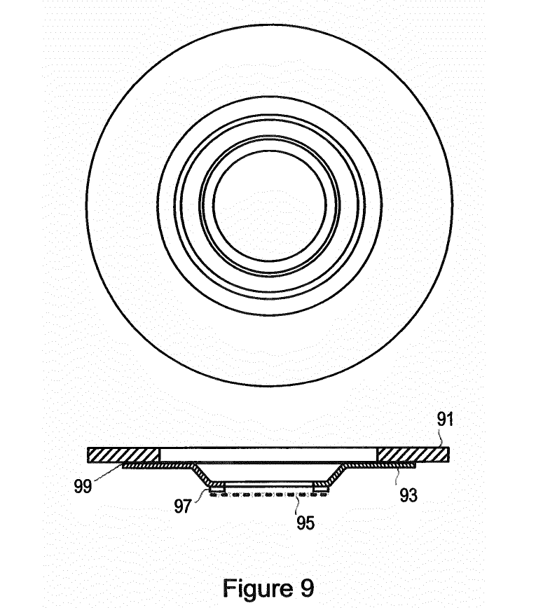

FIG. 9 shows an example in which this aspect of the invention is applied in an arrangement in which the vibrating platform comprises a single structure. The assembly comprises a vibrating platform 93 made from a material which passes UV light, for example a polymer material having this characteristic. The vibrating platform 93 has one side coupled to a vibrating element 91 using an adhesive 99 which is curable by UV light. The vibrating platform has another side coupled to an aperture plate 95 (such as a mesh or screen) using an adhesive 97 which is curable by UV light.

Although the embodiment of FIG. 9 shows a single piece vibrating platform 93, it is noted that the vibrating platforms of other embodiments, including two-piece vibrating platforms, can also be made from material which is transparent to UV light.

Thus, according to another aspect of the invention, there is provided an assembly for use in a liquid droplet apparatus. The assembly comprises a vibrating element, an aperture plate and a vibrating platform. The vibrating platform is positioned between the vibrating element and the aperture plate for conveying vibrations from the vibrating element to the aperture plate. The vibrating platform is made from a material that is transparent to a light source, for allowing the light source to cure an adhesive used in the assembly of one or more components of the assembly.

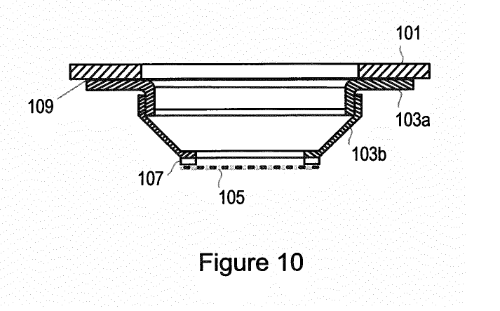

FIG. 10 shows such an example in which this aspect of the invention is applied in a vibrating platform comprising first and second portions, as described in the embodiments above. The embodiment of FIG. 10 comprises a vibrating element 101, for example a piezoelectric device, an aperture plate 105 and a vibrating platform 103. The vibrating platform 103 is positioned between the vibrating element 101 and the aperture plate 105, and is formed from a material that is transparent to UV light. The vibrating platform comprises a first portion 103a (for example having a fixed form) that is coupled to the vibrating element 101 using a UV curable adhesive 109, and a second portion 103b (for example a disposable portion having a flexible form) that is coupled to the aperture plate 105 using a UV curable adhesive 107. The first and second portions 63a, 63b of the vibrating platform are detachably connected.

From the embodiments described above it can be seen that, when the aperture plate needs to be replaced, the disposable screen section, that is the second portion of the vibrating platform (or disposable flex form) slides off or detaches from the first portion of the vibrating platform (or fixed form).

According to one embodiment an undercut is provided to retain the mesh in place, which can be snapped off when the mesh needs to be replaced.

The embodiments of the present invention as described above allow the mesh component to be separated by means of a secondary support structure or disposable flex form which is coupled to a primary support structure or fixed form that contains the permanently attached vibrating element, such as a piezo electric ring vibrating element.

This allows the assembly system to couple the fix form to disposable flex form components that allows for vibration energy to transmit from the piezoelectric element in order to vibrate the mesh to produce spray.

The embodiments of the invention can be applied to any form of respiratory drug delivery apparatus, including a nebulizer or atomizer.

Applications include respiratory care or sleep assistance nebulizer for delivery for home humidification via nasal cannula or mask.

The embodiments of the invention can be used to support efforts in home health care solutions as a part of a liquid nebulizer drug delivery system, or a humidification system for critical or home ventilation or sleep or nasal cannula via oxygen.

Embodiments of the invention provide a means and method to contain a mesh in a structure that allows detachment from the piezo ring actuator structure.

In the embodiments described above, it is noted that the aperture plate may comprise, for example, a screen, a mesh, a membrane, a machined metal plate, a polymer structure or the like, having many tiny openings or micro nozzles. It is noted that the aperture plate may be domed shaped, rather than flat as shown in the figures.

It is also noted that in some embodiments the vibrating platform, when assembled, comprises a first annular portion for coupling to a vibrating element, (for example a piezoelectric ring device), and a second annular portion for coupling to an aperture plate. The vibrating platform also comprises a sidewall for coupling the first annular portion and the second annular portion. When the vibrating platform is in an assembled configuration, the first annular portion lies in a first plane (for example corresponding to a bottom surface of the first annular portion) and the second annular portion lies in a second plane (for example corresponding to the bottom surface of the second annular portion). Also, when the vibrating platform is in an assembled configuration, the second plane is separated from and substantially in parallel with the first plane, and separated from and substantially in parallel with a third plane corresponding to a plane in which the vibrating element lies (for example corresponding to a bottom surface of the vibrating element). The sidewall which couples the first annular portion and the second annular portion therefore defines a cavity. It is noted that the aperture plate may be positioned, if desired, in this cavity.

It should be noted that the above-mentioned embodiments illustrate rather than limit the invention, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. An assembly for use in a liquid droplet apparatus, the assembly comprising:
a vibrating element;
an aperture plate; and
a vibrating platform;
wherein the vibrating platform is positioned between the vibrating element and the aperture plate for conveying vibrations from the vibrating element to the aperture plate, and wherein the vibrating platform comprises a first portion coupled to the vibrating element, a second portion coupled to the aperture plate, and wherein the first and second portions of the vibrating platform are detachably connected to one another.

2. An assembly as claimed in claim 1, wherein the first portion of the vibrating platform is fixedly coupled to the vibrating element, and the second portion of the vibrating platform is fixedly coupled to the aperture plate.

3. An assembly as claimed in claim 1, wherein the first portion of the vibrating platform is formed from a polymer material.

4. An assembly as claimed in claim 1, wherein the first portion of the vibrating platform is formed from a metal.

5. An assembly as claimed in claim 1, wherein the second portion of the vibrating platform is formed from a polymer material.

6. An assembly as claimed in claim 1, wherein the second portion of the vibrating platform is formed from a metal.

7. An assembly as claimed in claim 1, wherein the first portion and the second portions are of similar thicknesses.

8. An assembly as claimed in claim 1, wherein the first portion and the second portions are of different thicknesses.

9. An assembly as claimed in claim 1, wherein the vibrating platform is made from a material that is transparent to a light source, for allowing a light source to cure an adhesive used in the assembly of one or more components of the assembly.

10. An assembly as claimed in claim 1, wherein an interface between the first and second portions of the vibrating platform, where the first and second portions of the vibrating platform are detachably connected, comprises first and second surfaces which are generally orthogonal to a plane of the vibrating element.

11. An assembly as claimed in claim 1, wherein an interface between the first and second portions of the vibrating platform, where the first and second portions of the vibrating platform are detachably connected, comprises first and second surfaces which are sloped or slanted with respect to a plane of the vibrating element.

12. An assembly as claimed in claim 1, wherein the aperture plate is a mesh.

13. A first vibrating platform portion and a vibrating element for use in an assembly of a liquid droplet apparatus, the first vibrating platform portion being coupled to the vibrating element and comprising a detachable connection adapted for removably attaching the first vibrating element and the first vibrating platform portion to a second vibrating platform portion that is coupled to an aperture plate, wherein when the first and second vibrating platform portions are attached together vibrations generated by the vibrating element are transmitted through the vibrating platform portions causing the aperture plate to vibrate.

14. A second vibrating platform portion and an aperture plate for use in an assembly of a liquid droplet apparatus, the second vibrating platform portion being coupled to the aperture plate and comprising a detachable connection adapted for removably attaching the aperture plate and the second vibrating platform portion to a first vibrating platform portion that is coupled to a vibration element, wherein when the second and first second vibrating platform portions are attached together vibrations generated by the vibrating element are transmitted through the vibrating platform portions causing the aperture plate to vibrate.

15. A liquid droplet apparatus comprising an assembly according to claim 1.
